(19) United States
(12) Patent Application Publication
(10) Pub. No.: US 2019/0095636 A1
(43) Pub. Date: Mar. 28, 2019

(54) INFORMATION PROCESSING DEVICE AND MEDIUM STORING INFORMATION PROCESSING PROGRAM

(71) Applicant: FUJI XEROX CO., LTD., Tokyo (JP)

(72) Inventors: Yosuke SHINNAKA, Kanagawa (JP); Shigeki ISHINO, Kanagawa (JP); Yutaka SAKAI, Kanagawa (JP)

(73) Assignee: FUJI XEROX CO., LTD., Tokyo (JP)

(21) Appl. No.: 15/913,978

(22) Filed: Mar. 7, 2018

(30) Foreign Application Priority Data
Sep. 25, 2017 (JP) 2017-183303

(51) Int. Cl. G06F 21/62; G06F 21/34; H04L 9/32; H04L 29/06

(52) U.S. Cl. CPC G06F 21/6218; G06F 21/34; H04L 63/0853; H04L 63/083; H04L 9/3213

(57) ABSTRACT

An information processing device includes an acquiring unit configured to acquire second authentication information having an expiration date and required for authentication by an external device, by using previously stored first authentication information when an image is received; and a transmitting unit configured to connect to the external device by using the second authentication information, and transmit the image to the external device.

### CROSS-REFERENCE TO RELATED APPLICATIONS

This application is based on and claims priority under 35 USC 119 from Japanese Patent Application No. 2017-183303 filed Sep. 25, 2017.

### BACKGROUND

### Technical Field

The present invention relates to an information processing device and a medium storing an information processing program.

### SUMMARY

According to an aspect of the invention, there is provided an information processing device including an acquiring unit configured to acquire second authentication information having an expiration date and required for authentication by an external device, by using previously stored first authentication information when an image is received; and a transmitting unit configured to connect to the external device by using the second authentication information, and transmit the image to the external device.

### BRIEF DESCRIPTION OF THE DRAWINGS

Exemplary embodiments of the present invention will be described in detail based on the following figures, wherein:

FIG. 1 is a conceptual module configuration diagram for a configuration example according to a first exemplary embodiment;

FIG. 2 is an explanatory view illustrating a system configuration example using any of the exemplary embodiments;

FIG. 3 is an explanatory view illustrating a processing example according to the first exemplary embodiment;

FIG. 4 is an explanatory view illustrating a display example of an authentication information reception screen according to the first exemplary embodiment;

FIGS. 5A and 5B are explanatory views illustrating data structure examples of an authentication information table and a fax-number/authentication-information correspondence table;

FIG. 6 is a flowchart illustrating a processing example according to the first exemplary embodiment;

FIG. 7 is a flowchart illustrating a processing example according to the first exemplary embodiment;

FIG. 8 is a conceptual module configuration diagram for a configuration example according to a second exemplary embodiment;

FIG. 9 is an explanatory view illustrating a processing example according to the second exemplary embodiment;

FIG. 10 is an explanatory view illustrating a data structure example of a fax-number/authentication-information correspondence table;

FIG. 11 is a flowchart illustrating a processing example according to the second exemplary embodiment;

FIG. 12 is a flowchart illustrating a processing example according to the second exemplary embodiment; and

FIG. 13 is a block diagram illustrating a hardware configuration example of a computer that implements any of the exemplary embodiments.

### DETAILED DESCRIPTION

Various exemplary embodiments suitable for implementing the present invention will be described below with reference to the drawings.

### First Exemplary Embodiment

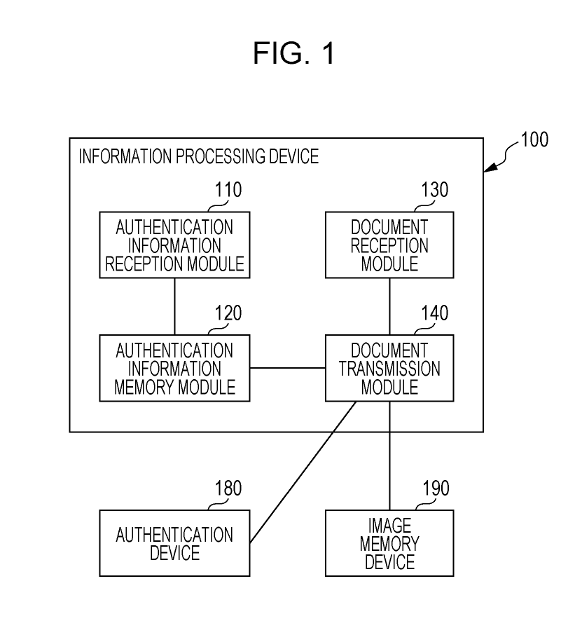

FIG. 1 is a conceptual module configuration diagram for a configuration example according to a first exemplary embodiment.

A module represents a component, such as software (a computer program) or hardware, which may be generally logically separated. Hence, a module in this exemplary embodiment represents not only a module of a computer program, but also a module of a hardware configuration. Therefore, description in any of the exemplary embodiments also involves a computer program that causes a computer to function as such a module (a program that causes a computer to execute respective steps, a program that causes a computer to function as respective units, and a program that causes a computer to provide respective functions), a system, and a method. For convenience of description, wordings “store,” “cause . . . to store,” and other wordings equivalent thereto are used. These wordings represent causing a memory device to store . . . or controlling a memory device to store . . . in the case in which the exemplary embodiment is a computer program. Also, modules may correspond to functions one by one. However, when being mounted or installed, a single module may be formed of a single program, plural modules may be formed of a single program, or a single module may be formed of plural programs. Also, plural modules may be executed by a single computer, or a single module may be executed by plural computers in a distributed or parallel environment. A single module may include another module. Also, “connection” is used for physical connection, and logical connection (for example, transmission and reception of data, an instruction, reference relationship among data, login, etc.). An expression “predetermined” represents being determined before target processing. The situation includes a situation before processing according to any one of exemplary embodiments is started, and a situation even after processing according to any of the exemplary embodiments is started as long as the situation is before target processing. In other words, the expression “predetermined” is used as being determined in accordance with the condition and state of the current situation, or the condition and state of the previous situation. If there are plural “predetermined values,” the values may be different, or two or more values (as a matter of course, all the values) may be the same. Also, an expression “if A, do B” is used as “determining whether A or not, and doing B if it is determined as A,” unless otherwise the determination whether A or not is not required. Also, if matters are listed like “A, B, and C,” the list are merely examples unless otherwise noted, and includes a case of selecting only one from the list (for example, only A).

Also, a system or an apparatus includes a case in which a system or an apparatus is formed of plural computers, plural pieces of hardware, plural devices, etc., connected by a communication measure such as a network (including communication connection in a one-to-one correspondence), and a case in which a system or an apparatus is provided by a single computer, a single piece of hardware, a single device, etc. An “apparatus” and a “system” are used as mutually equivalent words. As a matter of course, a “system” does not include a social “scheme” (social system) that is merely an artificial agreement.

Also, target information is read from a memory device every processing of each module or every processing if plural steps of processing are executed in a module, and after the processing, the processing result is written out to the memory device. Hence, the description of reading the information from the memory device before the processing and writing out the processing result to the memory device after the processing may be occasionally omitted. A memory device in this case may include a hard disk, a random access memory (RAM), an external storage medium, a memory device arranged via a communication line, and a register in a central processing unit (CPU).

An information processing device 100 according to the first exemplary embodiment receives an image and causes an image memory device 190 to store the image. As illustrated in FIG. 1, the information processing device 100 includes an authentication information reception module 110, an authentication information memory module 120, a document reception module 130, and a document transmission module 140. The information processing device 100 executes processing relating to management of authentication information when an image which is a document is transferred.

For example, when a fax document received by the information processing device 100 is transferred to the image memory device 190 which is an external server, even if authentication by the image memory device 190 is required, authentication information does not have to be input every reception by fax.

For example, the information processing device 100 retains first authentication information, acquires second authentication information having an expiration date and required for authentication by the image memory device 190 from the first authentication information at the reception by fax, and makes an access to the image memory device 190. The first authentication information may not have an expiration date. The image does not have to be obtained by the reception by fax, and an image may be obtained by reading an image by scanner. That is, when an image is read by scanner, the image may be transferred to the image memory device 190.

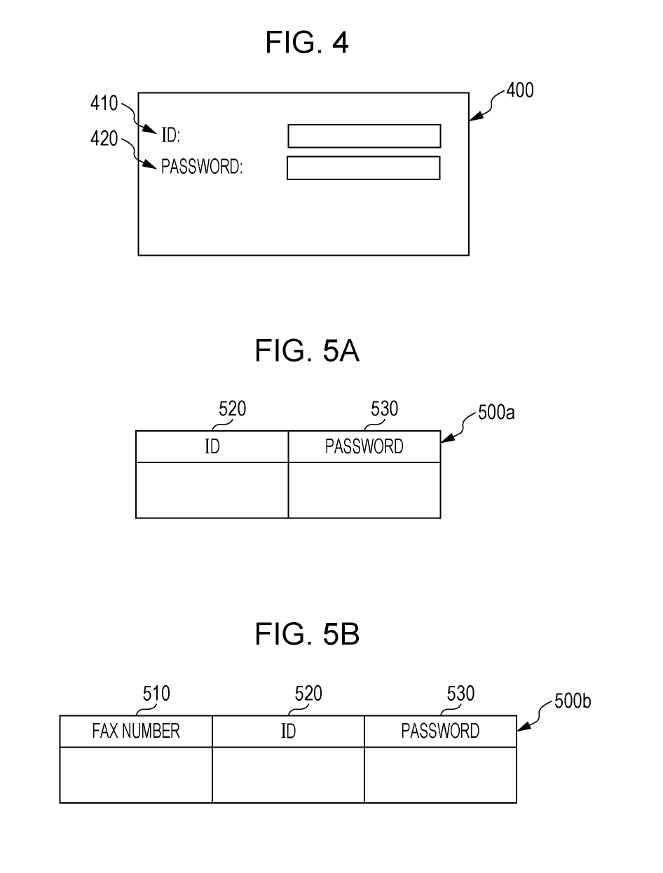

The authentication information reception module 110 is connected to the authentication information memory module 120. The authentication information reception module 110 receives the first authentication information. For example, the authentication information reception module 110 may receive a user identification (ID) and a password which are the first authentication information by using an authentication information reception screen 400. FIG. 4 is an explanatory view illustrating a display example of the authentication information reception screen 400 according to the first exemplary embodiment. On the authentication information reception screen 400 which is a Web user interface, an ID reception field 410 and a password reception field 420 are displayed. In the ID reception field 410, a user ID is received. In the password reception field 420, a password corresponding to the user ID is received. In this case, the user ID and the password are a user ID and a password in an authentication device 180.

Of course, the first authentication information may be any information other than the user ID and the password as long as the user is able to be authenticated with the information. For example, an IC card owned by the user may be read and information stored in the IC card may be verified, or the information may be living body information such as a fingerprint.

The authentication information memory module 120 is connected to the authentication information reception module 110 and the document transmission module 140. The authentication information memory module 120 stores the first authentication information. The authentication information memory module 120 may further store the second authentication information. Also, the authentication information memory module 120 may store the first authentication information and the second authentication information in an encoded manner. For example, the authentication information memory module 120 stores an authentication information table 500a or a fax-number/authentication-information correspondence table 500b. FIG. 5A is an explanatory view illustrating a data structure example of the authentication information table 500a. The authentication information table 500a has an ID field 520 and a password field 530. The ID field 520 stores a user ID. The password field 530 stores a password corresponding to the user ID. FIG. 5B is an explanatory view illustrating a data structure example of the fax-number/authentication-information correspondence table 500b. The fax-number/authentication-information correspondence table 500b has a fax number field 510, an ID field 520, and a password field 530. That is, the fax-number/authentication-information correspondence table 500b is obtained by adding the fax number field 510 to the authentication information table 500a. The fax number field 510 stores a fax number. Either of the authentication information table 500a and the fax-number/authentication-information correspondence table 500b may be used. In this case, an example using the fax-number/authentication-information correspondence table 500b is described.

For example, when an image received by fax is transferred to the image memory device 190, the document transmission module 140 extracts the user ID and the password corresponding to the fax number at the reception, from the fax-number/authentication-information correspondence table 500b. The document transmission module 140 is connected to the authentication device 180 by using the extracted user ID and password.

For example, when an image read by scanner is transmitted to the image memory device 190, the document transmission module 140 extracts the user ID and the password of a user who logs in the information processing device 100, from the fax-number/authentication-information correspondence table 500b. The document transmission module 140 is connected to the authentication device 180 by using the extracted user ID and password.

The document reception module 130 is connected to the document transmission module 140. The document reception module 130 receives an image. An image may be received, for example, by receiving an image by fax or by reading an image by scanner.

The document transmission module 140 is connected to the authentication information memory module 120, the document reception module 130, the authentication device 180, and the image memory device 190. When the document reception module 130 receives an image, the document transmission module 140 acquires second authentication information having an expiration date and required for authentication by the image memory device 190 which is an external device, by using previously stored first authentication information. That is, the document transmission module 140 acquires the second authentication information from the first authentication information.

The document transmission module 140 is connected to the image memory device 190 by using the second authentication information, and transmits the image received by the document reception module 130 to the image memory device 190. That is, the document transmission module 140 transfers the image to the image memory device 190. The document transmission module 140 may add the second authentication information to the image when transferring the image.

Also, the document transmission module 140 may transmit first authentication information to the authentication device 180, and may acquire second authentication information from the authentication device 180. Specifically, the document transmission module 140 makes an access to the authentication device 180, and acquires token information (access token) which is the second authentication information, from the user ID and the password which are the first authentication information. The second authentication information is not limited to the access token, and may include a refresh token.

Also, when the first authentication information is changed, the document transmission module 140 may change the first authentication information in the authentication information memory module 120 that stores the first authentication information, into changed first authentication information. If the first authentication information is changed (for example, if the password is changed), transfer of an image may be failed. Hence, when the first authentication information is changed, a notification is made for re-inputting the first authentication information. Otherwise, when the first authentication information is changed, a system that manages the first authentication information may re-write the first authentication information.

The authentication device 180 is connected to the document transmission module 140 of the information processing device 100. The authentication device 180 allows an access to a different application or system (in this case, the image memory device 190) only by authenticating the user by using the first authentication information, and getting the authentication once. Hence, an existing authentication device 180 may be used. For example, a technology, such as OAuth or Single Sign-On, may be used.

The image memory device 190 is connected to the document transmission module 140 of the information processing device 100. The image memory device 190 receives and stores an image transmitted from the information processing device 100. The image memory device 190 is also called image server. For example, the image memory device 190 may have a function of storing an image received by the fax of the information processing device 100. Alternatively or additionally, the image memory device 190 may have a function of storing an image read by the scanner of the information processing device 100.

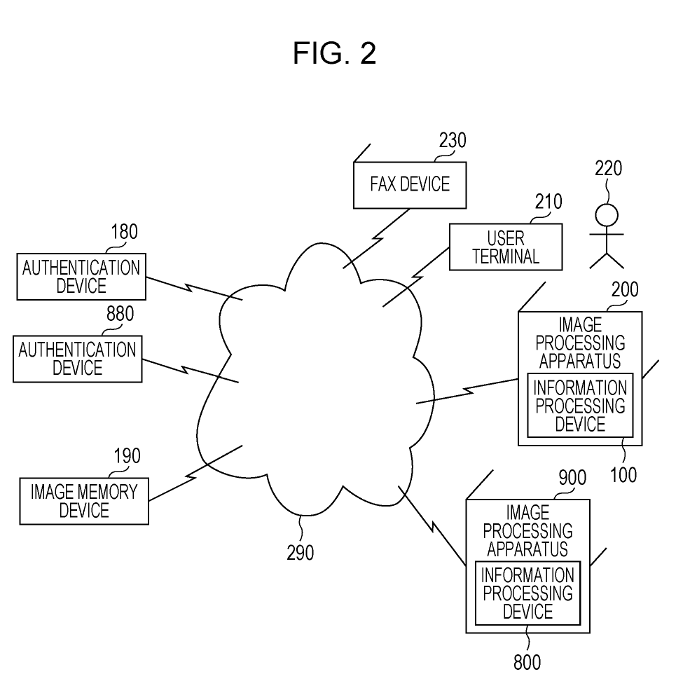

FIG. 2 is an explanatory view illustrating a system configuration example using any of the exemplary embodiments.

An image processing apparatus 200 includes the information processing device 100. The image processing apparatus 200 is, for example, a fax, a scanner, or a multi-function machine (an image processing apparatus having at least two functions of a scanner, a printer, a copier, a fax, etc.). An image processing apparatus 900 includes an information processing device 800. A user terminal 210 is used by a user 220. The authentication device 180, an authentication device 880, the image memory device 190, the image processing apparatus 200, the user terminal 210, a fax device 230, and the image processing apparatus 900 are connected to one another via a communication line 290. The communication line 290 may have a wireless configuration, a wired configuration, or a combination of both. For example, the communication line 290 may be the Internet or an intranet as a communication infrastructure. Also, the functions of the authentication device 180, the authentication device 880, and the image memory device 190 may be provided as a cloud service.

For example, an image is transmitted by fax from the fax device 230 to the image processing apparatus 200. The information processing device 100 in the image processing apparatus 200 is connected to the image memory device 190 by using the authentication device 180, and transmits the image received from the fax device 230 to the image memory device 190. Then, the user 220 who has received the fax references the image in the image memory device 190 by using the user terminal 210.

Alternatively, for example, an image is read by the scanner of the image processing apparatus 200 through an operation by the user 220. The information processing device 100 in the image processing apparatus 200 is connected to the image memory device 190 by using the authentication device 180, and transmits the image read by scanner to the image memory device 190. Then, the user 220 references the image in the image memory device 190 by using the user terminal 210.

A processing example using the image processing apparatus 900 and the authentication device 880 will be described later as a second exemplary embodiment.

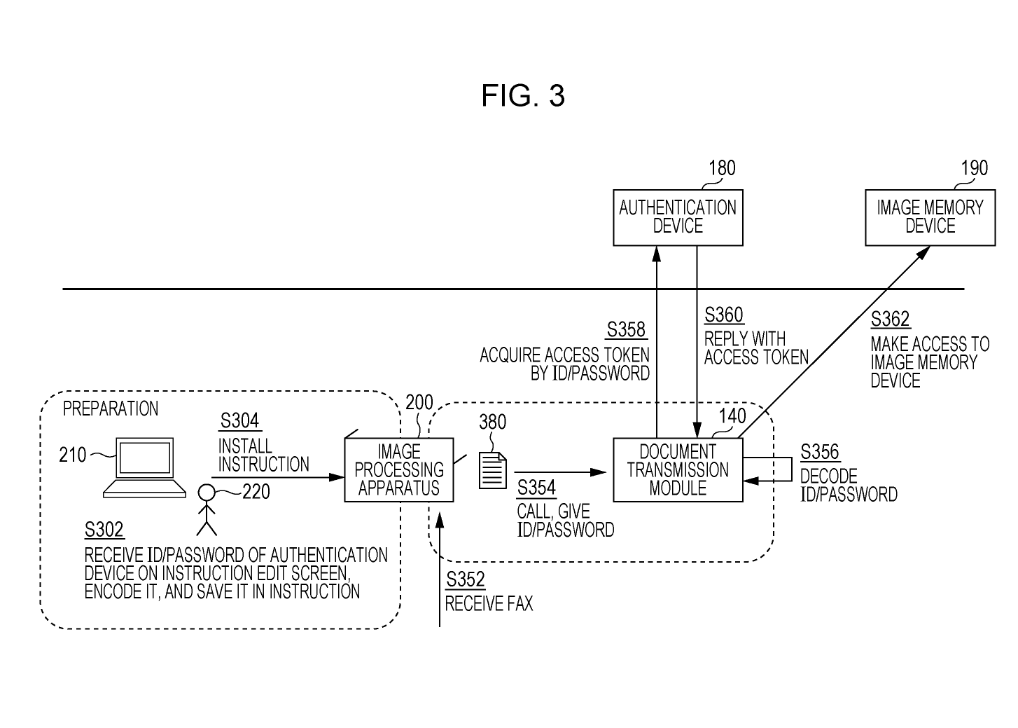

FIG. 3 is an explanatory view illustrating a processing example according to the first exemplary embodiment.

In step S302, the image processing apparatus 200 receives a user ID and a password of the authentication device 180 on an instruction edit screen of the user terminal 210, encodes the user ID and the password, and saves the user ID and the password in an instruction. The instruction is a file that stores an instruction item with respect to the image processing apparatus 200 (specifically, when a fax to the user 220 is received, a work flow of transmitting the fax image to the image memory device 190). In this case, the instruction stores at least the user ID and the password of the user 220 in the authentication device 180. Alternatively, in a state in which the instruction is installed in the image processing apparatus 200, the instruction content (user ID, password, etc.) may be edited through the user interface of the image processing apparatus 200.

In step S304, the user terminal 210 installs the instruction in the image processing apparatus 200 through an operation by the user 220.

In step S352, the image processing apparatus 200 receives an image by the fax function. Thereafter, the processing is executed in accordance with an instruction job 380.

In step S354, the information processing device 100 calls (activates) the document transmission module 140, and gives the user ID and the password to the document transmission module 140.

In step S356, the document transmission module 140 decodes the user ID and the password.

In step S358, the document transmission module 140 makes a request to acquire an access token from the authentication device 180 by using the user ID and the password.

In step S360, the authentication device 180 makes a reply with the access token to the document transmission module 140.

In step S362, the document transmission module 140 makes an access to the image memory device 190 by using the access token, and transfers the received image.

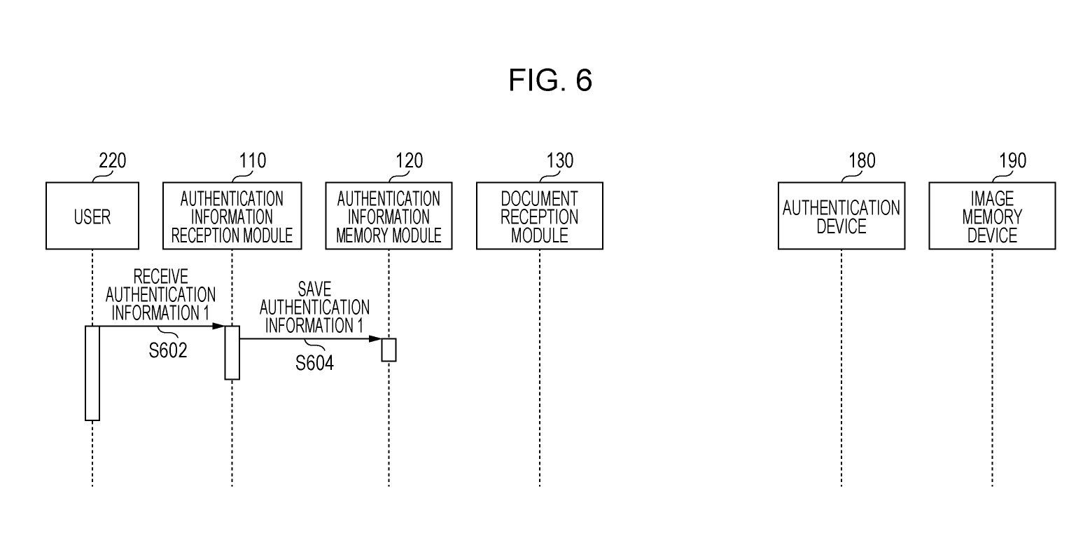

FIG. 6 is a flowchart illustrating a processing example according to the first exemplary embodiment. This is processing to be executed before an image is received, and is processing of storing authentication information (first authentication information) for the authentication device 180, previously in the authentication information memory module 120.

In step S602, the authentication information reception module 110 receives the first authentication information through an operation by the user 220. The first authentication information may be received via the user terminal 210, or via the user interface of the image processing apparatus 200.

In step S604, the authentication information reception module 110 causes the authentication information memory module 120 to save the first authentication information.

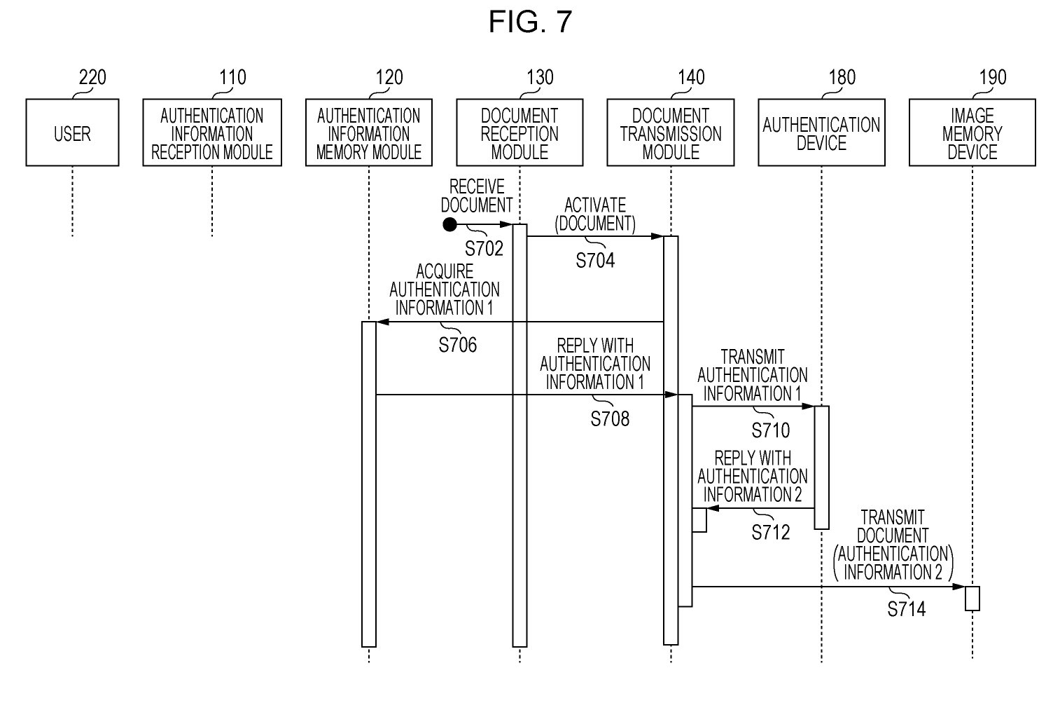

FIG. 7 is a flowchart illustrating a processing example according to the first exemplary embodiment. This is processing to be executed after an image is received, and is processing of transferring the image to the image memory device 190 by using the authentication device 180.

In step S702, the document reception module 130 receives an image which is a document by fax.

In step S704, the document reception module 130 activates the document transmission module 140.

In step S706, the document transmission module 140 makes a request to acquire first authentication information from the authentication information memory module 120.

In step S708, the authentication information memory module 120 makes a reply with the first authentication information to the document transmission module 140.

In step S710, the document transmission module 140 transmits the first authentication information to the authentication device 180.

In step S712, the authentication device 180 makes a reply with second authentication information to the document transmission module 140.

In step S714, the document transmission module 140 transmits the document and the second authentication information to the image memory device 190. Login is made in the image memory device 190 by using the second authentication information. The image memory device 190 receives the image, and stores the image in a storage area corresponding to the log-in user.

### Second Exemplary Embodiment

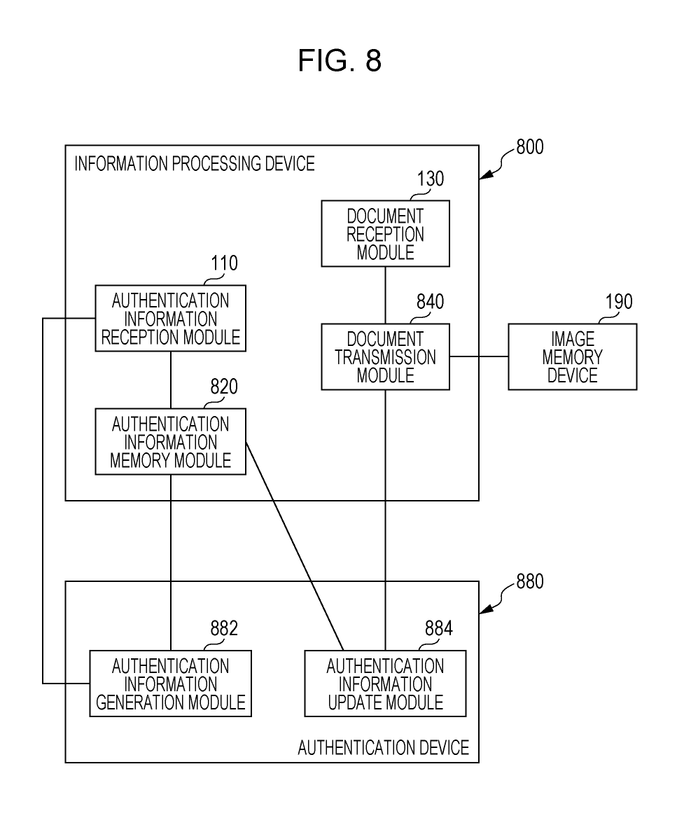

FIG. 8 is a conceptual module configuration diagram for a configuration example according to a second exemplary embodiment.

An information processing device 800 according to the second exemplary embodiment receives an image and causes an external device to store the image. As illustrated in FIG. 8, the information processing device 800 includes an authentication information reception module 110, an authentication information memory module 820, a document reception module 130, and a document transmission module 840. The same reference sign is applied to a portion of the same kind as that according to the first exemplary embodiment, and its redundant description is omitted.

The authentication information reception module 110 is connected to the authentication information memory module 820, and an authentication information generation module 882 of an authentication device 880.

The document reception module 130 is connected to the document transmission module 840.

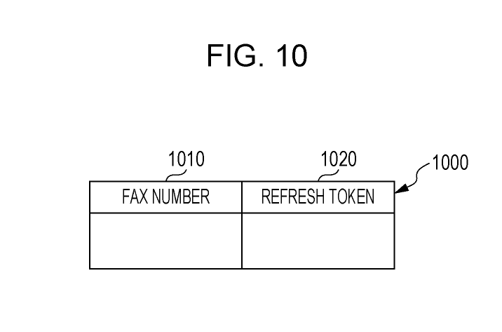

The authentication information memory module 820 is connected to the authentication information reception module 110, and the authentication information generation module 882 and an authentication information update module 884 of the authentication device 880. The authentication information memory module 820 transmits first authentication information to the authentication device 880, and stores second authentication information acquired by a reply from the authentication device 880. For example, the authentication information memory module 820 stores a fax-number/authentication-information correspondence table 1000. FIG. 10 is an explanatory view illustrating a data structure example of the fax-number/authentication-information correspondence table 1000. The fax-number/authentication-information correspondence table 1000 has a fax number field 1010 and a refresh token field 1020. The fax number field 1010 stores a fax number. The refresh token field 1020 stores a refresh token.

For example, when an image received by fax is transferred to an image memory device 190, the document transmission module 840 extracts a refresh token corresponding to the fax number at the reception, from the fax-number/authentication-information correspondence table 1000. Then, the document transmission module 840 acquires an access token from the authentication device 880 by using the extracted refresh token, and is connected to the image memory device 190 by using the access token.

The fax number field 1010 in the fax-number/authentication-information correspondence table 1000 may be a user ID field that stores a user ID. In this case, for example, when an image read by scanner is transmitted to the image memory device 190, the document transmission module 840 extracts the refresh token with reference to the user ID of the user who logs in the information processing device 800 by using the fax-number/authentication-information correspondence table 1000. Then, the document transmission module 840 acquires an access token from the authentication device 880 by using the extracted refresh token, and is connected to the image memory device 190 by using the access token.

The document transmission module 840 is connected to the document reception module 130, the authentication information update module 884 of the authentication device 880, and the image memory device 190. When the document reception module 130 receives an image, the document transmission module 840 acquires third authentication information having an expiration date and required for authentication by the image memory device 190 which is an external device, by using the second authentication information stored in the authentication information memory module 820.

The document transmission module 840 is connected to the image memory device 190 by using the third authentication information, and transmits the image received by the document reception module 130 to the image memory device 190. That is, the document transmission module 840 transfers the image to the image memory device 190. The document transmission module 840 may add the third authentication information to the image when transferring the image.

Also, the document transmission module 840 may transmit the second authentication information to the authentication device 880, and may acquire the third authentication information from the authentication device 880.

Further, the third authentication information acquired by the document transmission module 840 may include a refresh token and an access token. That is, the authentication device 880 transmits the refresh token and the access token as the third authentication information to the information processing device 800.

The document transmission module 840 may be connected to the image memory device 190 by using the access token, and may transfer the image to the image memory device 190.

Also, the document transmission module 840 may cause the authentication information memory module 820 to store the refresh token as the second authentication information.

Also, if the refresh token has expired, the authentication information reception module 110 may notify the user about the expiration. That is, if the refresh token has expired, transfer of a document may be failed. Hence, the expiration date of the refresh token is continually checked, and if the expiration date ends, the user is notified about the expiration.

The authentication information reception module 110 may receive first authentication information through an operation by the user (re-input of the first authentication information by the user). The authentication information memory module 820 may transmit the received first authentication information to the authentication device 880, and may store second authentication information acquired by a reply from the authentication device 880.

The authentication device 880 includes the authentication information generation module 882 and the authentication information update module 884.

The authentication information generation module 882 is connected to the authentication information reception module 110 and the authentication information memory module 820 of the information processing device 800. The authentication information generation module 882 receives first authentication information, generates second authentication information, and transmits the second authentication information to the information processing device 800.

The authentication information update module 884 is connected to the authentication information memory module 820 and the document transmission module 840 of the information processing device 800. The authentication information update module 884 updates the second authentication information and extends the expiration date. Specifically, the authentication information update module 884 updates a refresh token included in token information in response to an access from the information processing device 800, and makes a reply with the updated token information.

The image memory device 190 is connected to the document transmission module 840 of the information processing device 800.

As illustrated in the example in FIG. 2, the image processing apparatus 900 including the information processing device 800 may be connected to the communication line 290. In this case, the authentication device 880 may be used.

For example, an image is transmitted by fax from the fax device 230 to the image processing apparatus 900. The information processing device 800 in the image processing apparatus 900 is connected to the image memory device 190 by using the authentication device 880, and transmits the image received from the fax device 230 to the image memory device 190. Then, the user 220 who has received the fax references the image in the image memory device 190 by using the user terminal 210.

Alternatively, for example, an image is read by the scanner of the image processing apparatus 900 through an operation by the user 220. The information processing device 800 in the image processing apparatus 900 is connected to the image memory device 190 by using the authentication device 880, and transmits the image read by scanner to the image memory device 190. Then, the user 220 references the image in the image memory device 190 by using the user terminal 210.

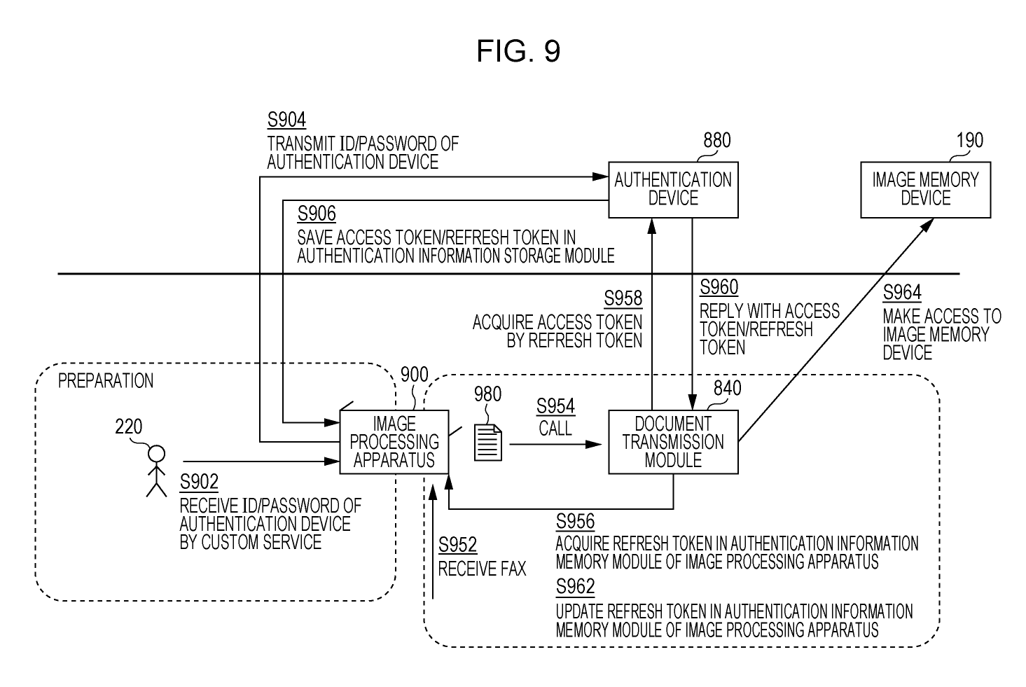

FIG. 9 is an explanatory view illustrating a processing example according to the second exemplary embodiment.

In step S902, the image processing apparatus 900, as the authentication information reception module 110, receives an ID and a password of the authentication device 880 through an operation by the user 220.

In step S904, the image processing apparatus 900 transmits the ID and the password of the authentication device 880 to the authentication device 880.

In step S906, the authentication device 880 transmits an access token and a refresh token to the image processing apparatus 900. The authentication information memory module 820 in the information processing device 800 saves the access token and the refresh token. The authentication information memory module 820 saves the access token and the refresh token, and then the processing is ended. In step S956, the saved refresh token is acquired.

In step S952, the image processing apparatus 900 receives an image by the fax function. Thereafter, the processing is executed in accordance with an instruction job 980.

In step S954, the information processing device 800 calls (activates) the document transmission module 840. In the second exemplary embodiment, the user ID and the password are not given.

In step S956, the document transmission module 840 acquires the refresh token which is stored in a storage area of the image processing apparatus 900 by the authentication information memory module 820 of the image processing apparatus 900. The authentication information memory module 820 stores the refresh token in the storage area (hard disk etc.) of the image processing apparatus 900. The instruction job 980 does not have the refresh token.

In step S958, the document transmission module 840 makes a request to acquire an access token from the authentication device 880 by using the refresh token.

In step S960, the authentication device 880 makes a reply with the access token and the refresh token to the document transmission module 840.

In step S962, the document transmission module 840 updates the refresh token in the authentication information memory module 820 of the image processing apparatus 900.

In step S964, the document transmission module 840 makes an access to the image memory device 190 by using the access token, and transfers the received image.

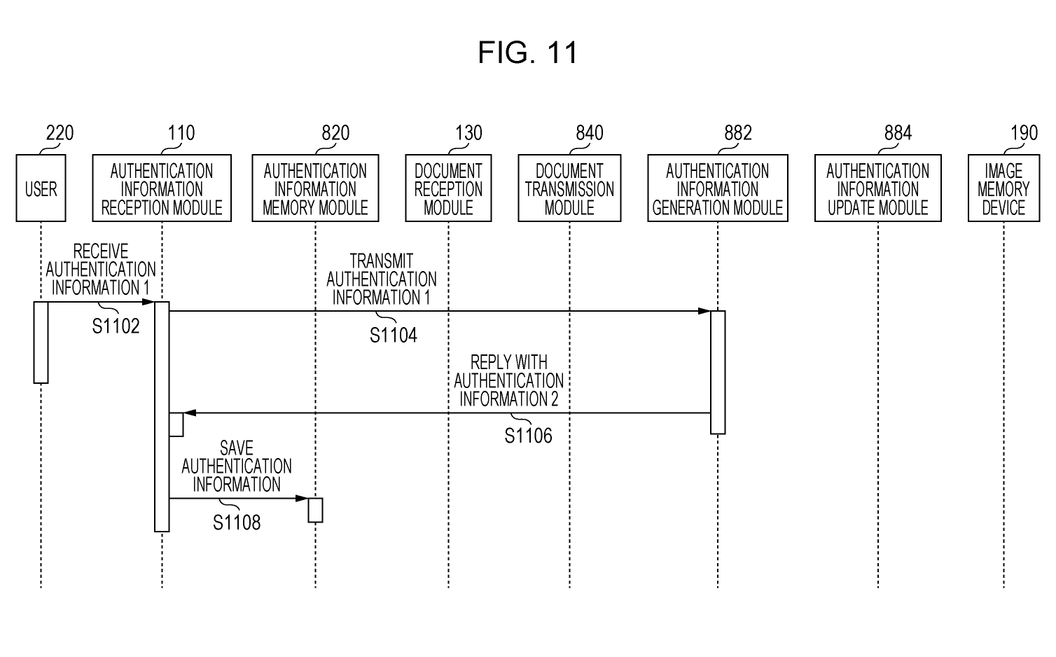

FIG. 11 is a flowchart illustrating a processing example according to the second exemplary embodiment. This is processing to be executed before an image is received, and is processing of storing authentication information (second authentication information) for the authentication device 880, previously in the authentication information memory module 820.

In step S1102, the authentication information reception module 110 receives first authentication information through an operation by the user 220. The authentication information reception module 110 may receive the first authentication information via the user terminal 210, or via the user interface of the image processing apparatus 900.

In step S1104, the authentication information reception module 110 transmits the first authentication information to the authentication information generation module 882.

In step S1106, the authentication information generation module 882 makes a reply with second authentication information to the authentication information reception module 110.

In step S1108, the authentication information reception module 110 causes the authentication information memory module 820 to save the second authentication information.

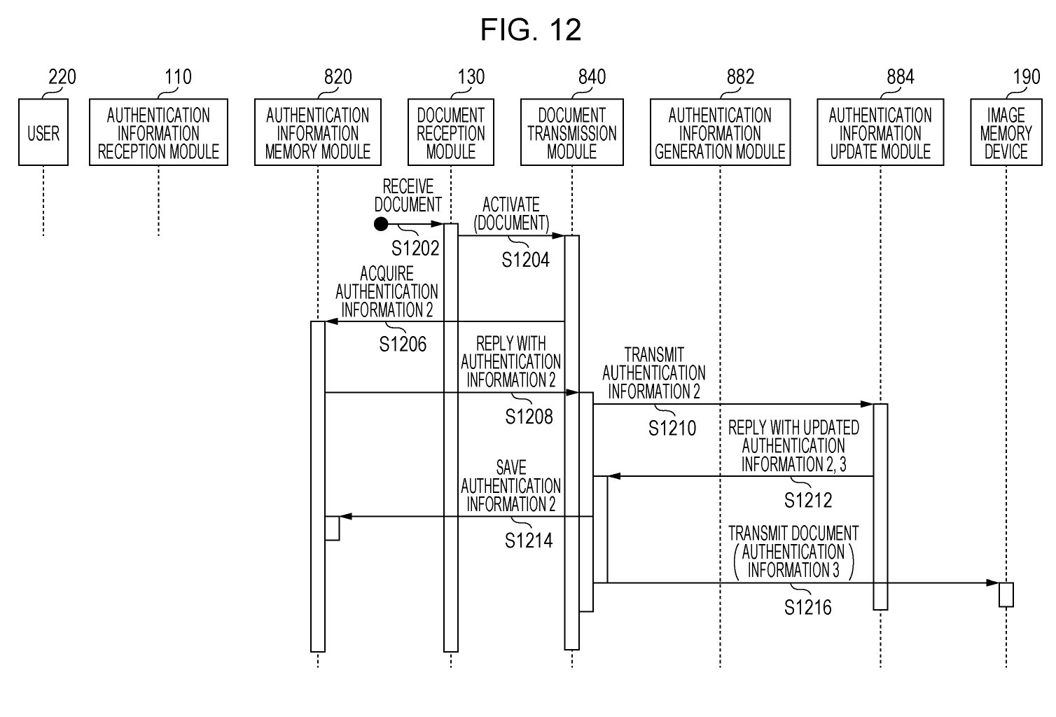

FIG. 12 is a flowchart illustrating a processing example according to the second exemplary embodiment. This is processing to be executed after an image is received, and is processing of transferring the image to the image memory device 190 by using the authentication device 880.

In step S1202, the document reception module 130 receives an image which is a document by fax.

In step S1204, the document reception module 130 activates the document transmission module 840.

In step S1206, the document transmission module 840 makes a request to acquire second authentication information from the authentication information memory module 820.

In step S1208, the authentication information memory module 820 makes a reply with the second authentication information to the document transmission module 840.

In step S1210, the document transmission module 840 transmits the second authentication information to the authentication information update module 884.

In step S1212, the authentication information update module 884 makes a reply with the updated second authentication information and third authentication information to the document transmission module 840.

In step S1214, the document transmission module 840 causes the authentication information memory module 820 to save the second authentication information.

In step S1216, the document transmission module 840 transmits the document and the third authentication information to the image memory device 190. Login is made in the image memory device 190 by using the third authentication information. The image memory device 190 receives the image, and stores the image in a storage area corresponding to the log-in user.

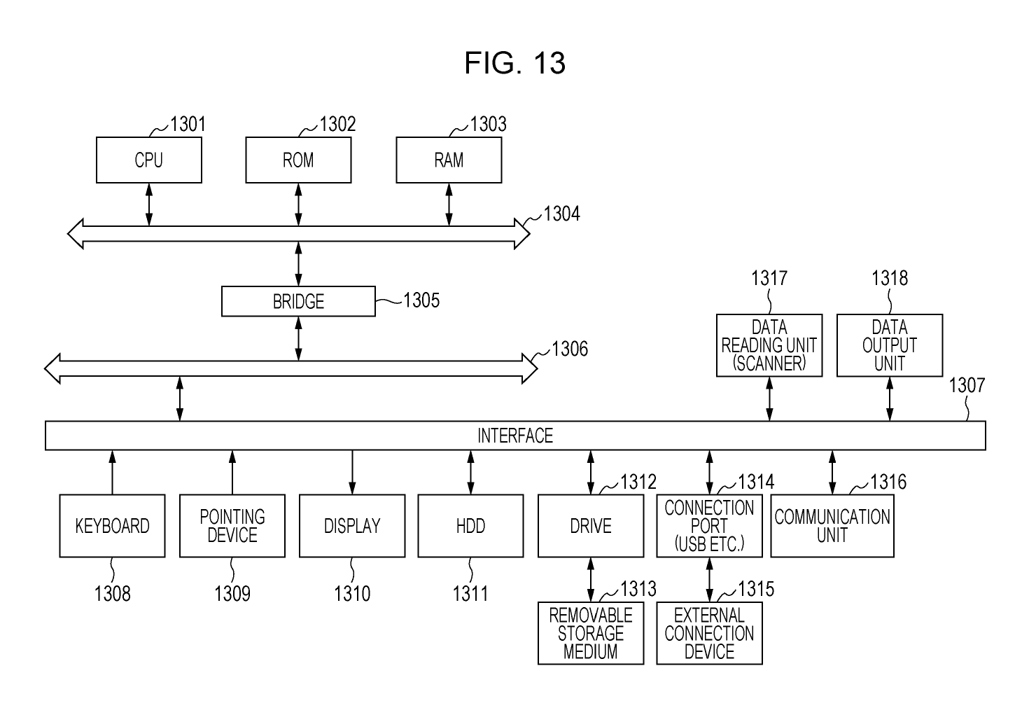

With reference to FIG. 13, a hardware configuration example of the information processing device (the information processing device 100, the authentication device 180, the image memory device 190, the information processing device 800, the authentication device 880) according to any of the exemplary embodiments is described. The configuration illustrated in FIG. 13 is formed of, for example, a personal computer (PC), and is a hardware configuration example including a data reading unit 1317 such as a scanner, and a data output unit 1318 such as a printer.

A central processing unit (CPU) 1301 is a controller that executes processing according to a computer program having written therein execution sequences of the various modules described in the exemplary embodiments, that is, the respective modules, such as the authentication information reception module 110, the document reception module 130, the document transmission module 140, the authentication information generation module 882, and the authentication information update module 884.

A read only memory (ROM) 1302 stores a program, an operation parameter, etc., used by the CPU 1301. A random access memory (RAM) 1303 stores a program to be used during the execution by the CPU 1301, a parameter that is appropriately changed during the execution, etc. The CPU 1301, the ROM 1302, and the RAM 1303 are mutually connected via a host bus 1304 formed of, for example, a CPU bus.

The host bus 1304 is connected to an external bus 1306 such as a peripheral component interconnect/interface (PCI) bus via a bridge 1305.

A keyboard 1308 and a pointing device 1309 such as a mouse are devices that are operated by an operator. A display 1310 is a liquid crystal display device, a cathode ray tube (CRT), or the like, and displays various information as text and image information. Alternatively, the display 1310 may be a touch screen or the like including both the functions of the pointing device 1309 and the display 1310. In this case, to provide the function of the keyboard, a keyboard does not have to be physically connected unlike the keyboard 1308, a keyboard (what is called software keyboard, screen keyboard, etc.) may be plotted with software on a screen (touch screen), and hence the function of the keyboard may be provided.

A hard disk drive (HDD) 1311 includes a hard disk (or flash memory etc.) therein, drives the hard disk, and causes the hard disk to record or reproduce a program to be executed by the CPU 1301 and information. The hard disk provides the functions as the authentication information memory module 120, the authentication information memory module 820, etc. Further, the hard disk stores various data and various computer programs.

A drive 1312 reads data or a program recorded in a mounted removable storage medium 1313, such as a magnetic disk, an optical disc, a magneto-optical disk, or a semiconductor memory, and supplies the data or program to the RAM 1303 connected via an interface 1307, the external bus 1306, the bridge 1305, and the host bus 1304. The removable storage medium 1313 may be also used as a data recording area.

A connection port 1314 is a port that connects an external connection device 1315, and has a connection portion, such as USB or IEEE 1394. The connection port 1314 is connected to the CPU 1301 and other units via the interface 1307, the external bus 1306, the bridge 1305, the host bus 1304, etc. A communication unit 1316 is connected to a communication line and executes data communication processing with an external device. The data reading unit 1317 is, for example, a scanner, and executes reading processing for a document. The data output unit 1318 is, for example, a printer, and executes output processing for document data.

The hardware configuration of the information processing apparatus illustrated in FIG. 13 is merely a configuration example. The configuration of any of the exemplary embodiments is not limited to the configuration illustrated in FIG. 13, and may be any configuration as long as the modules described in each of the exemplary embodiments may be executed. For example, a portion of the modules may be formed of dedicated hardware (for example, application specific integrated circuit (ASIC) or the like), a portion of the modules may be arranged in an external system and may be connected via a communication line, and further the system illustrated in FIG. 13 may be multiple systems mutually connected via a communication line and the multiple systems may operate in an associated manner. Alternatively, in particular, a portion of the modules may be arranged in any of a mobile information communication apparatus (including a mobile phone, a smart phone, a mobile device, a wearable computer, and so forth), a home information appliance, a robot, a copier, a fax, a scanner, a printer, and a multiple-function device (an image processing apparatus having at least two functions of a scanner, a printer, a copier, and a fax), instead of a personal computer.

The above-described program may be stored in a storage medium and provided. Alternatively, the program may be provided by a communication measure. In this case, for example, the above-described program may be interpreted as an aspect of the invention of “a computer-readable medium storing a program.”

“The computer-readable medium storing the program” represents a computer-readable medium storing a program, the medium which is used for, for example, installation, execution, and distribution of the program.

For example, the storage medium may include a digital versatile disk (DVD), particularly, “DVD-R, DVD-RW, DVD-RAM, and the like” complying with the standard formulated by the DVD forum, “DVD+R, DVD+RW, and the like” complying with the standard formulated as DVD+RW; a compact disc (CD), particularly, a compact disc read only memory (CD-ROM), a compact disc recordable (CD-R), a compact disc rewritable (CD-RW), and the like; a Blu-ray (registered trademark) disc; a magneto-optical disk (MO); a flexible disk (FD); a magnetic tape; a hard disk; a read only memory (ROM); an electrically erasable programmable ROM (EEPROM, registered trademark); a flash memory; a random access memory (RAM); a secure digital (SD) memory card; and the like.

The entirety or a portion of the above-described program may be recorded in the storage medium, and may be stored and distributed. Also, the entirety or a portion of the above-described program may be transmitted by using a wired network, a wireless communication network, a transmission medium with a combination of the wired network and the wireless communication network, used for a local area network (LAN), a metropolitan area network (MAN), a wide area network (WAN), the Internet, an intranet, an extranet, or the like; or may be carried on a carrier wave.

Further, the program may be the entirety or a portion of another program, or may be recorded in a storage medium together with a different program. Alternatively, the program may be divided and recorded in plural storage media. Also, the program may be recorded in any form, for example, a compressed form or an encoded form, as long as the program may be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an acquiring unit configured to acquire second authentication information having an expiration date and required for authentication by an external device, by using previously stored first authentication information when an image is received; and
a transmitting unit configured to connect to the external device by using the second authentication information, and transmit the image to the external device.

2. The information processing device according to claim 1,
wherein the acquiring unit transmits the first authentication information to an authentication device, and acquires the second authentication information from the authentication device.

3. The information processing device according to claim 1,
wherein, when the first authentication information is changed, first authentication information in a memory that stores the first authentication information is changed into changed first authentication information.

4. An information processing device comprising:
a memory configured to transmit first authentication information to an authentication device, and that stores second authentication information acquired by a reply from the authentication device;
an acquiring unit configured to acquire third authentication information having an expiration date and required for authentication by an external device by using the second authentication information stored in the memory when an image is received; and
a transmitting unit configured to connect to the external device by using the third authentication information, and transmit the image to the external device.

5. The information processing device according to claim 1,
wherein the reception of the image is reception of an image by a fax.

6. The information processing device according to claim 4,
wherein the reception of the image is reception of an image by a fax.

7. The information processing device according to claim 5,
wherein the external device has a function as a memory device that stores the image received by the fax.

8. The information processing device according to claim 6,
wherein the external device has a function as a memory device that stores the image received by the fax.

9. The information processing device according to claim 4,
wherein the acquiring unit transmits the second authentication information to the authentication device, and acquires the third authentication information from the authentication device.

10. The information processing device according to claim 9,
wherein the third authentication information acquired by the acquiring unit includes a refresh token and an access token, and
wherein the transmitting unit is connected to the external device by using the access token, and transmits the image to the external device.

11. The information processing device according to claim 10,
wherein the refresh token is stored as the second authentication information in the memory.

12. The information processing device according to claim 10, further comprising:
a notifying unit that makes a notification to a user if the refresh token has expired.

13. The information processing device according to claim 12,
wherein the first authentication information is received through an operation by the user, and
wherein the memory transmits the received first authentication information to the authentication device, and stores second authentication information acquired by a reply from the authentication device.

14. A non-transitory computer readable medium storing a program causing a computer to execute a process for information processing, the process comprising:
acquiring second authentication information having an expiration date and required for authentication by an external device, by using previously stored first authentication information when an image is received; and
making connection to the external device by using the second authentication information, and transmitting the image to the external device.

15. A non-transitory computer readable medium storing a program causing a computer to execute a process for information processing, the process comprising:
transmitting first authentication information to an authentication device, and storing second authentication information acquired by a reply from the authentication device;
acquiring third authentication information having an expiration date and required for authentication by an external device, by using the stored second authentication information when an image is received; and
making connection to the external device by using the third authentication information, and transmitting the image to the external device.
